(19) United States
(12) Patent Application Publication
(10) Pub. No.: US 2025/0004814 A1
(43) Pub. Date: Jan. 2, 2025

(54) INCREASING THE STORAGE CAPACITY OF A STORAGE CLUSTER

(71) Applicant: Dell Products, L.P., Round Rock, TX (US)

(72) Inventors: David Leimbach, Mechanicsburg, PA (US); Michael Burriss, Raleigh, NC (US); John Reimer, Madison, WI (US); Raymond Ramsden, Seattle, WA (US); Steven Soumpholphakdy, Chicago, IL (US); Mammootty Muthira, San Jose, CA (US)

(21) Appl. No.: 18/345,026

(22) Filed: Jun. 30, 2023

(51) Int. Cl. G06F 9/455

(52) U.S. Cl. CPC G06F 9/45558; G06F 2009/4557; G06F 2009/45583

(57) ABSTRACT

The technologies described herein are generally directed toward increasing a storage capacity of a storage cluster. In an embodiment, a method can include identifying a cluster for a change in storage capacity, the cluster having been deployed using a set of node devices that support the cluster. The method can further include, based on a capacity specification, deploying a virtual machine on a node device that is not part of the set of node devices. Further, the method can include, based on a capacity specification, merging the node device into the set of node devices, resulting in a merged set of node devices to support the cluster and achieve the change in storage capacity.

### BACKGROUND

Modern data systems can operate functions within virtual machines. Different approaches can be used to improve the performance and scalability of virtual machines. Because modern systems can rely upon the complex interactions of multiple virtual machines, coordinating the addition of additional virtual machines to expand the storage capacity of a system can be challenging.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can include a processor and a memory that stores executable instructions that, when executed by the processor, facilitate performance of operations. The instructions can include an instruction to identify a cluster for a change in storage capacity, the cluster having been deployed using a set of node devices that support the cluster. Additionally, the instructions can include an instruction to, based on a capacity specification, deploy a virtual machine on a node device that is not part of the set of node devices. Further, the instructions can include an instruction to, based on a capacity specification, merge the node device into the set of node devices, resulting in a merged set of node devices to support the cluster and achieve the change in storage capacity. Additionally, or alternatively, in some embodiments, deploying the virtual machine can include, based on the set of node devices and the cluster, generating metadata associated with the virtual machine and creating the virtual machine that can include storing the metadata with the virtual machine to be accessible via the virtual machine. Additionally, or alternatively, in some embodiments, the metadata can include additional information including but not limited to, a serial number generated for the virtual machine prior to deploying the virtual machine.

Additionally, or alternatively, in some embodiments, the set of node devices can include a range of network addresses to facilitate support of the cluster, with the method further including, based on the capacity specification, expanding the range of network addresses to accommodate merging the node device into the set of node devices.

Additionally, or alternatively, in some embodiments, the node device can include a first node device, and the method further can further include, based on the capacity specification, deploying, by the system, a second node device different from the first node device. In this regard, merging the first node device into the set of node devices can include asynchronously merging the first node device and the second node device into the set of node devices to support the cluster and achieve the change in storage capacity. Additionally, or alternatively, in some embodiments, the method can further include, validating, by the system, the deploying of the node device, and the change in storage capacity of the cluster as a result of merging the node device.

Additionally, or alternatively, the method can further include, before deploying the virtual machine on the node device, determining that merging the node device into the set of node devices is not going to result in a limit on number of node devices, which are allowed to be included in the set of node devices, being exceeded. Additionally, or alternatively, the method can further include, before deploying the virtual machine on the node device, determining, by the system, that the set of node devices are functioning in accordance with a node specification. Additionally, or alternatively, in some embodiments, deploying the virtual machine on the node device comprises creating a virtual network interface card to support the virtual machine. Additionally, or alternatively, in some embodiments, identifying the cluster for the change in storage capacity can include, based on a capacity condition, monitoring the storage capacity of the cluster, and based on the monitoring and the capacity condition, generating the capacity specification.

An example method can include identifying a cluster for a change in storage capacity, the cluster having been deployed using a set of node devices that support the cluster. The method can further include, based on a capacity specification, deploying a virtual machine on a node device that is not part of the set of node devices. Further, the instructions can include, based on a capacity specification, merging the node device into the set of node devices, resulting in a merged set of node devices to support the cluster and achieve the change in storage capacity.

Additionally, or alternatively, in one or more embodiments, receiving the capacity specification comprises receiving the capacity specification based on a determination that the storage cluster requested additional storage capacity beyond a current storage capacity of the storage cluster. Additionally, or alternatively, in one or more embodiments, the capacity specification was generated to achieve a specified change in a storage capacity of the storage cluster. Additionally, or alternatively, in one or more embodiments, merging the storage equipment into the group of storage equipment supporting the storage cluster comprises integrating the virtual machine to support the storage cluster by performing a function of the storage cluster.

An example non-transitory computer-readable medium can include instructions that, in response to execution, cause a system including a processor to perform operations. These operations can include identifying a cluster for a change in storage capacity, the cluster having been deployed using a set of node devices that support the cluster. The operations can further include, based on a capacity specification, deploying a virtual machine on a node device that is not part of the set of node devices. The operations can further include, based on a capacity specification, merging the node device into the set of node devices, resulting in a merged set of node devices to support the cluster and achieve the change in storage capacity.

In additional or alternative embodiments, deploying the virtual machine can include, based on the node devices and the cluster, generating metadata associated with the virtual machine, and creating the virtual machine to comprise the metadata. In additional or alternative embodiments, the node devices can include a range of network addresses to facilitate the supporting of the cluster, and the operations can further include, based on the capacity specification, expanding the range of network addresses to accommodate merging the node device into the node devices supporting the cluster. In additional or alternative embodiments, the operations can further include validating deployment of the node device and a storage capacity of the node device.

In additional or alternative embodiments, the operations can further include, before deploying the virtual machine on the node device, determining that merging the node device into the node devices will not exceed a maximum number of node devices in the node devices. In additional or alternative embodiments, the operations can further include, before deploying the virtual machine on the node device, determining that the node devices are functioning consistent with at least one specification of a node specification.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system that can facilitate increasing the storage capacity of a storage cluster, in accordance with one or more embodiments.

FIG. 2 is an architecture diagram of an example system that can facilitate increasing storage capacity of a storage cluster, in accordance with one or more embodiments.

FIG. 3 continues the depiction of the architecture diagram of FIG. 2 providing the example systems can facilitate increasing storage capacity of a storage cluster, in accordance with one or more embodiments.

FIG. 4 is a part of an example sequence diagram of a system that can change the storage capacity of a storage cluster, in accordance with one or more embodiments.

FIG. 5 is a part of the example sequence diagram of the system of FIG. 4 that can change the storage capacity of a storage cluster, in accordance with one or more embodiments.

FIG. 6 depicts a flow diagram representing example operations of an example method 600 that can facilitate increasing storage capacity of a storage cluster, in accordance with one or more embodiments.

FIG. 7 depicts an example system that can facilitate increasing storage capacity of a storage cluster, in accordance with one or more embodiments.

FIG. 8 depicts an example non-transitory machine-readable medium that can include executable instructions that, when executed by a processor of a system, can facilitate increasing storage capacity of a storage cluster, in accordance with one or more embodiments.

FIG. 9 depicts an example schematic block diagram of a computing environment with which the disclosed subject matter can interact, in accordance with one or more embodiments.

FIG. 10 illustrates an example block diagram of a computer operable to execute an embodiment of this disclosure.

### DETAILED DESCRIPTION

Generally speaking, one or more embodiments described herein can facilitate increasing the storage capacity of a storage cluster. One or more embodiments can use different approaches to retrieve data from streaming storage.

As is understood by one having skill in the relevant art(s), given the description herein, the implementation(s) described herein are non-limiting examples, and variations to the technology can be implemented. For instance, even though many examples described herein discuss cloud storage devices, the technologies described herein can be used in many applicable circumstances, e.g., storing streams data with other types of data storage. As such, any of the embodiments, aspects, concepts, structures, functionalities, implementations and/or examples described herein are non-limiting, and the technologies described and suggested herein can be used in various ways that provide benefits and advantages to data manipulation system technology in general, both for existing technologies and technologies in this and similar areas that are yet to be developed.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

Generally, one or more embodiments can facilitate the use of cloud storage systems for the storage and retrieval of streaming data, e.g., a continuous and unbounded data flow that can be generated by various data sources with high data volumes and velocity.

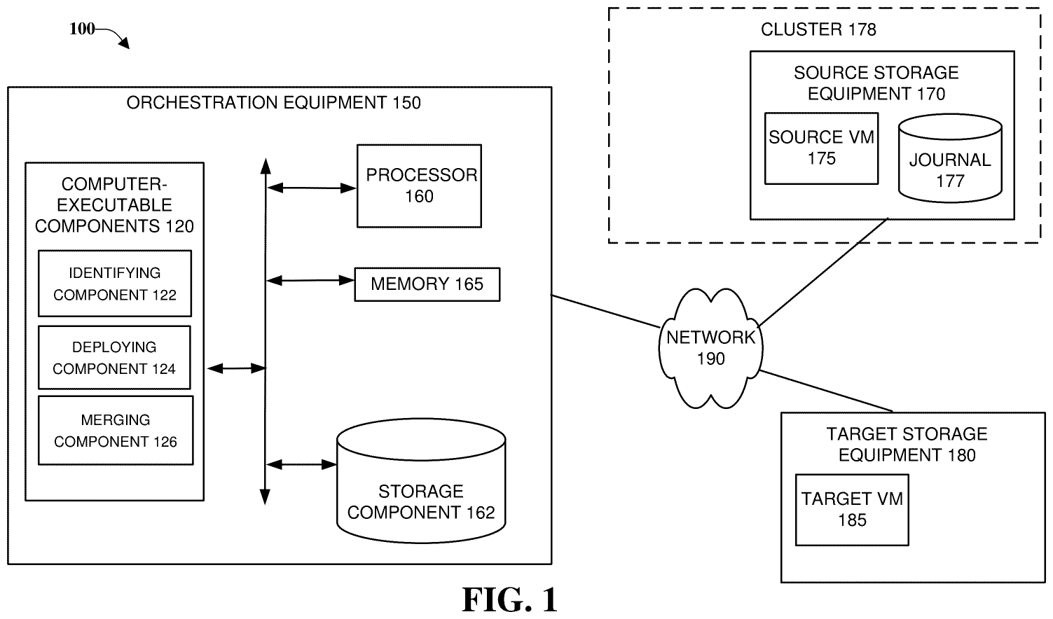

FIG. 1 is an architecture diagram of an example system 100 that can facilitate increasing the storage capacity of a storage cluster, in accordance with one or more embodiments. For purposes of brevity, description of like elements and/or processes employed in other embodiments is omitted.

As depicted, system 100 includes orchestration equipment 150 connected to source storage equipment 170, and target storage equipment 180 via network 190. Source storage equipment 170 includes source VM 175, and target storage equipment 180 includes target VM 185. System 100 further includes cluster 178, with functions of cluster 178 supported by source storage equipment 170 and other storage equipment with other virtual machines (not shown). In some implementations cluster 178 can be supported by a set of node devices, also termed a nodepool, herein. As used herein, a nodepool refers to a logical grouping of storage nodes within the cluster (e.g., cluster 178), and a storage node may also be known as a storage equipment, e.g., storage equipment 170. In embodiments, a nodepool may facilitate management and organization of storage resources within the cluster, e.g., a group/set of associated nodes within a cluster that have the same configuration, e.g., groups of disk pools spread across similar, or compatible, storage nodes.

Orchestration equipment 150 includes memory 165, processor 160, and storage component 162. According to multiple embodiments, memory 165 of orchestration equipment 150 can store one or more computer and/or machine readable, writable, and/or executable components 120 and/or instructions. In one or more embodiments, computer-executable components 120, when executed by processor 160, can facilitate performance of operations defined by the executable component(s) and/or instruction(s). Computer executable components 120 can include identifying component 122, deploying component 124, merging component 126, and other components described or suggested by different embodiments described herein, that can improve the operation of system 100 or other systems described herein.

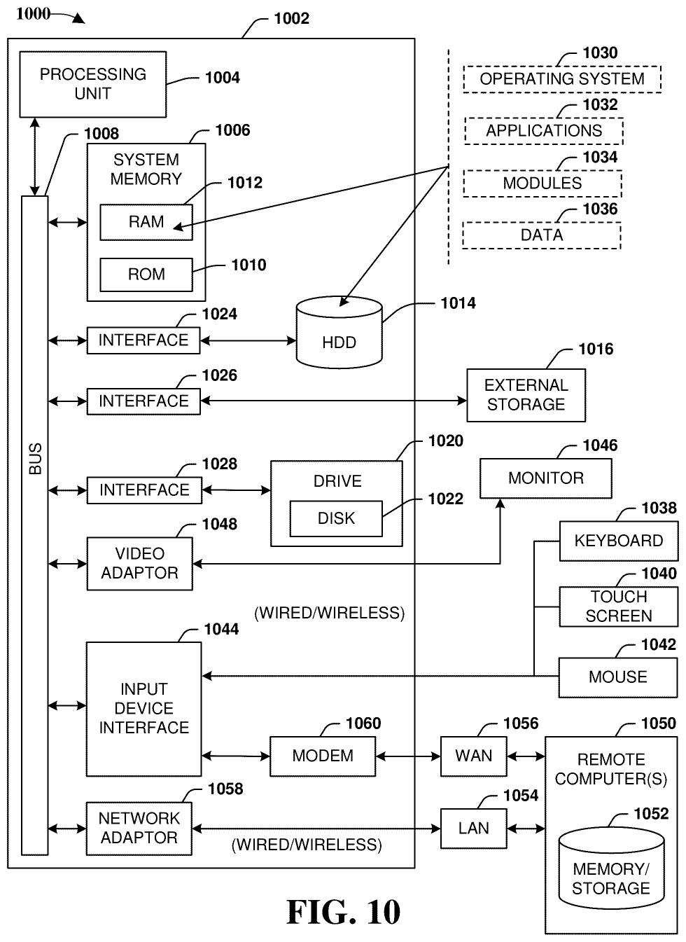

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor 160 are described below with reference to processing unit 1004 of FIG. 10. Such examples of processor 160 can be employed to implement any embodiments of the subject disclosure.

As discussed further with FIG. 10 below, network 190 can employ various wired and wireless networking technologies. For example, embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), fifth generation core (5G Core), fifth generation option 3x (5G Option 3x), high speed packet access (HSPA), Z-Wave, Zigbee and other 802.XX wireless technologies and/or legacy telecommunication technologies.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1006 and FIG. 10. Such examples of memory 165 can be employed to implement any embodiments of the subject disclosure. In some embodiments, memory 165 can comprise non-volatile random-access memory (NVRAM), with different uses including journaled manipulation of storage component 162 data and the enabling of concurrent updating of some types of stored data, in accordance with one or more embodiments.

It is understood that the computer processing systems, computer-implemented methods, apparatus, and computer program products described herein employ computer hardware and/or software to solve problems that are highly technical in nature (e.g., utilizing cloud storage protocols to store potentially high-velocity unbounded data streams), that are not abstract and cannot be performed as a set of mental acts by a human. For example, a human, or even a plurality of humans, cannot efficiently handle the complex, rapid storage of streaming data according to cloud storage provider requirements.

In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate generation of identifying component 122, which can in some implementations, identify a cluster for scaling, deployed using a first node device of a set of node devices supporting the cluster, wherein the first node device has a first virtual machine deployed thereon to support a function of functions of the cluster. For example, one or more embodiments can identify cluster 178 for scaling, deployed using a source storage equipment 170 having source VM 175 deployed thereon to support a function of functions of the cluster.

In another example, memory 165 can store executable instructions that can facilitate generation of deploying component 124, which can, in some implementations, based on a scaling specification, deploy a second virtual machine on a second node device. For example, one or more embodiments, deploying component 124 can, based on a scaling specification, deploy target VM 185 on target storage equipment 180.

In another example, memory 165 can store executable instructions that can facilitate generation of merging component 126, which in some implementations can, based on the scaling specification, expand performance of the function from the first virtual machine to the second virtual machine. For example, one or more embodiments can, based on the scaling specification, transfer the function, from source VM 175 to target VM 185.

It is appreciated that the embodiments of the subject disclosure depicted in various figures disclosed herein are for illustration only, and as such, the architecture of such embodiments are not limited to the systems, devices, and/or components depicted therein. For example, in some embodiments, orchestration equipment 150 can further comprise various computer and/or computing-based elements described herein with reference to operating environment 1000 and FIG. 10. In one or more embodiments, such computer and/or computing-based elements can be used in connection with implementing one or more of the systems, devices, components, and/or computer-implemented operations shown and described in connection with FIG. 1 or other figures disclosed herein.

It should be noted that orchestration equipment 150, and other equipment discussed herein, can execute code instructions that may operate on servers or systems, remote data centers, or ‘on-box’ in individual client information handling systems, according to various embodiments herein. In some embodiments, it is understood any or all implementations of one or more embodiments described herein can operate on a plurality of computers, collectively referred to as orchestration equipment 150. For example, one or more of orchestration equipment 150, and other equipment discussed herein can all be separate subsystems running in the kernel of a computing device as well as operating on separate network equipment, e.g., as depicted in FIG. 1.

Example data storage systems which can employ one or more of the approaches described with embodiments herein include, but are not limited to EMC ISILON®, a non-limiting example network attached storage (NAS) platform provided by DELL EMC, Inc. Example storage array devices which can employ one or more of the approaches described with embodiments herein include, but are not limited to, POWERSCALE® enterprise data storage array system provided by DELL EMC, Inc.

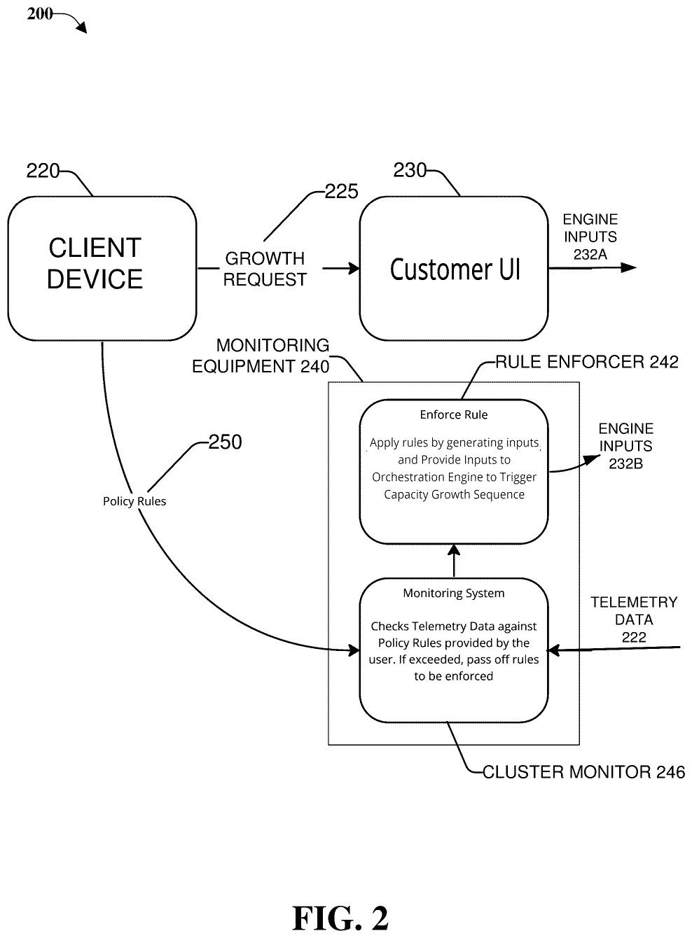

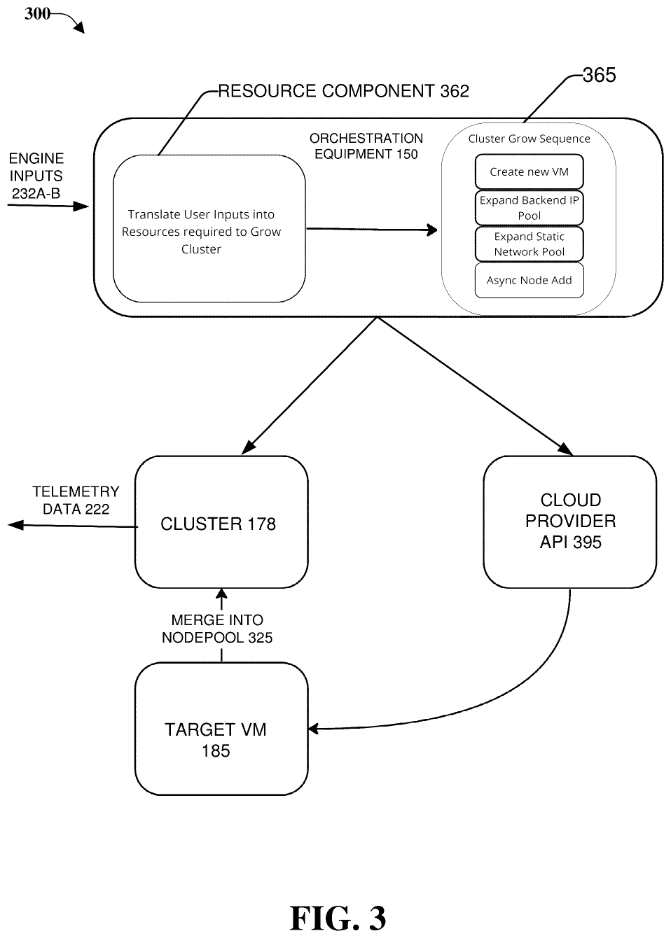

FIGS. 2 and 3 are architecture diagrams of connected example systems 200 and 300 that can facilitate increasing storage capacity of a storage cluster, in accordance with one or more embodiments. For purposes of brevity, description of like elements and/or processes employed in other embodiments is omitted.

System 200 includes client device 220, customer user interface (UI) 230, monitoring equipment 240 that includes rule enforcer 242 and cluster monitor 246. Customer UI 230 receives growth request 225 from client device 220, and communicates engine inputs 232A to orchestration equipment 150, which includes cluster grow sequence 365 and resource component 362. System 300 further includes cluster 178 providing telemetry data 222 to cluster monitor 246, target VM 185, and cloud provider API 395. Cluster monitor 246 can receive policy rules 250 from client device 220.

In a first approach to causing an expansion of the storage capacity of cluster 178, the cluster growth is triggered by growth request 225 from client device 220 via customer user interface (UI) 230. Orchestration engine 360 receives engine inputs 232A based on growth request 225, and translates the user inputs into a capacity specification for resources required to grow the storage capacity of cluster 178 by a selected amount. Alternatively, growth request 225 can include a request to expand an existing cluster by a selected amount. In one or more embodiments, growth request 225 is a direct request from client device 220 that is not based on monitoring of cluster 178. As such, engine inputs 232A represent this client requested approach to expanding capacity.

Additionally, or alternatively, instead of a specific request from client device 220 causing the change in capacity, engine inputs 232B can be generated by rule enforcer 242 based on monitoring of the operation of cluster 178 by cluster monitor 246. In this approach, policy rules 250 can be generated based on input from client device 220, e.g., maximum number of nodes that can be deployed to support cluster, minimum and maximum available storage capacity of cluster 178, and/or other capacity characteristics of cluster 178.

Continuing this example, cluster 178 can capture and provide telemetry 222 to cluster monitor 246, where policy rules 250 can be used as criteria for evaluating telemetry 222. In one or more embodiments, cluster monitor 246 can check telemetry data 222 against policy rules 350, and, if rules are implicated, communicate relevant rules to rule enforcer 242. Based on processing by rule enforcer 242, engine inputs 232B are generated and relayed to orchestration equipment 150 for storage capacity modification of cluster 178.

In this example, engine inputs 232A-B can be received by resource component 362 and translated by resource component 362 into a capacity specification that identifies resources required to grow cluster in accordance with policy rules 350, e.g., by identifying component 122. In one or more embodiments, in accordance with cluster grow sequence 365 and based on the capacity specification, instructions can be provided to cluster 178 and cloud provider application programming interface (API) 450, to configure and deploy target VM 185 support the cluster and achieve the change in storage capacity, e.g., by deploying component 124. In embodiments, target VM 185 can be merged into the set of node devices (e.g., nodepool) based on instructions from cloud provider API 395, e.g., by merging component 126.

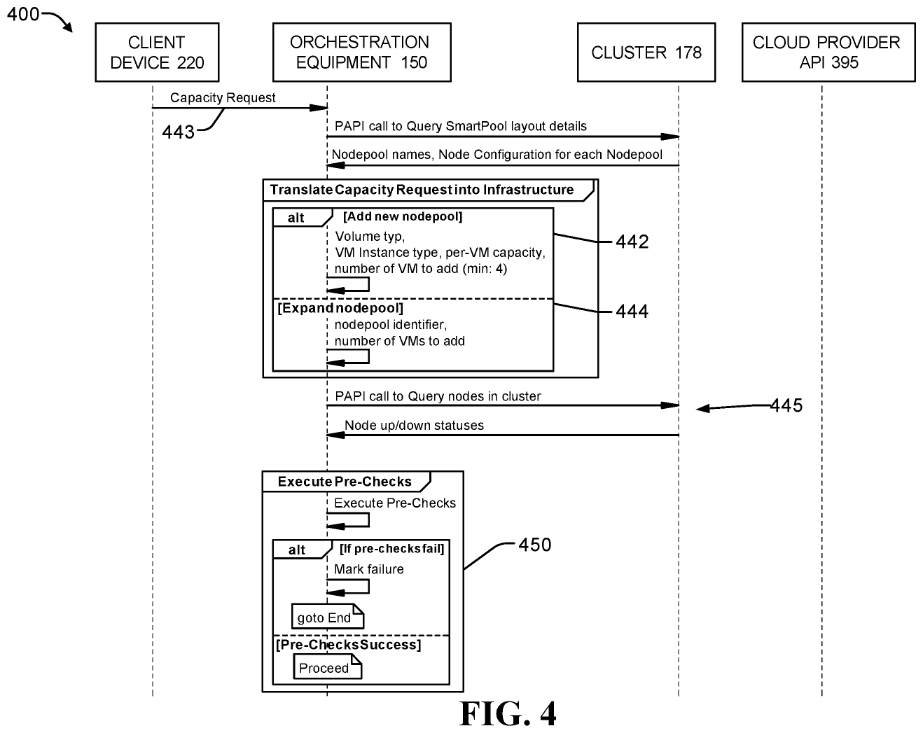

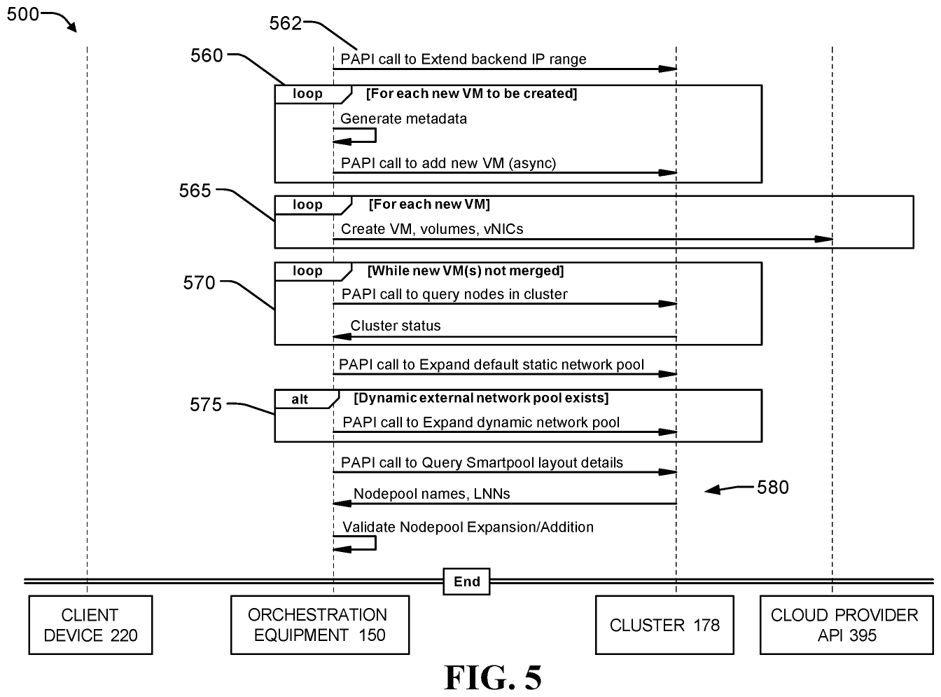

FIGS. 4 and 5 are two parts of an example sequence diagram in parts 400 and 500 that illustrates increasing the storage capacity of a storage cluster, in accordance with one or more embodiments. For purposes of brevity, description of like elements and/or processes employed in other embodiments is omitted.

Sequence diagram 400 includes exchanges of information between client device 220, orchestration equipment 150, cluster 178, and cloud provider API 395. At reference number 443, a capacity request is received (e.g., from client device 220). In an example implementation, this request can include a request to generate a new nodepool for the new VMs, or alternatively, to expand an existing nodepool to accommodate the new VMs generated. In implementations, both of these request types can include requested results to be achieved from the request including, but not limited to, an increased storage capacity and a desired level of performance from the additional capacity.

At reference number 442, for an example that includes a request to add new nodepools to increase capacity, the requested results may be translated into parameters for creation of new volumes and VMs, e.g., new volume type, a number of new VMs, types for the new VMs, and capacity per VM. For example, for a requested result that includes a resulting increase in capacity, a capacity added per VM may be used to specify a number of VMS required to achieve the capacity result requested. Similarly, for a requested performance result, an estimate of performance increases per added VM can be used to specify the number of VMS to be created.

Alternatively, at reference number 444, where an existing nodepool is expanded, a nodepool identifier for the nodepool to be expanded is specified along with the requested results from the expansion in capacity. In this example, to select a number of nodes to add to the existing nodepool to achieve the requested capacity, the nodepool identifier can be used to request information from the cluster about the nodepool, such as the current number and capacity of nodes within the nodepool. Based on this existing capacity and the additional capacity requested, orchestration equipment 150 can select a number of like-nodes (e.g., nodes compatible with existing nodes of the nodepool) that need to be added to meet the expansion request, as well as the number of VMs required for the new nodes.

At reference number 445, to facilitate adding a new nodepool to the service of cluster 178, an API call can be made to query nodes of cluster 178, and status reports can be received from cluster 178. At reference number 450, orchestration equipment 150 can execute pre-checks to determine whether the new nodes can be added to cluster 178.

After successful pre-checks, in FIG. 5 at reference number 562, an API call to extend IP ranges can be made from orchestration equipment 150 to cluster 178, e.g., to facilitate accommodation of the new nodes. At 560, for each new VM to be created, metadata can be generated for the VMs to be launched. In an example, metadata including serial numbers may be auto-generated for each of the VMs, and these serial numbers can be used with an API call to facilitate asynchronously adding each VM to the new or existing nodes. In an example, this API call adds the VM request to a queue of VMs to be added to the new or existing nodes as the nodes are detected by backend. In some implementations, using asynchronous API calls may facilitate nodes being joined to the cluster as they are detected, e.g., without having to wait for each new node being added one-by-one with a separate API call.

At reference number 565, new VMs and corresponding virtual network interface cards (vNICs) can be created, e.g., by deploying component 124. At reference number 570, while the new VMs and nodes have not been merged into nodepool, and the API call can be made from orchestration equipment 150 to cluster 178, e.g., for status reports to further facilitate merging the new node into the existing nodepool. At reference number 575, a default static network pool can be expanded for cluster 178, e.g., by merging component 126.

At reference number 580, an API call can be made to receive layout details for the expanded cluster, with these layout details including information such as nodepool names and logical node numbers (LNN) for the new nodes created for the new nodepool, or for the new nodes added the existing nodepool. In addition, the layout details can include the new capacity for the new or existing nodepools based on the addition of the new VMs. As further included at reference number 580, in some implementations, this new capacity may be used to validate that the expanded capacity of the cluster was expanded to the extent that was expected and/or requested by the capacity request discussed with reference number 443 above.

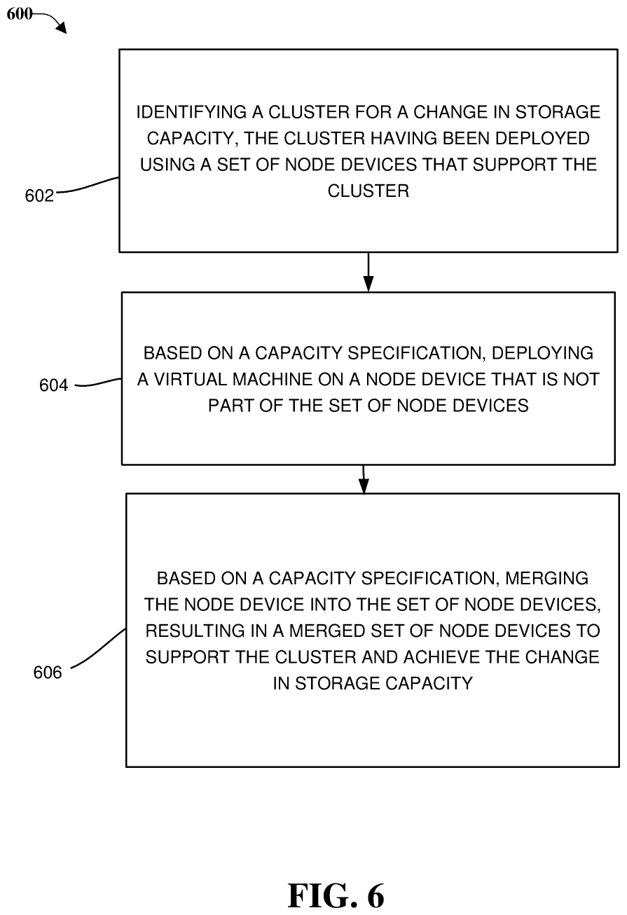

FIG. 6 depicts a flow diagram representing example operations of an example method 600 that can facilitate increasing storage capacity of a storage cluster, in accordance with one or more embodiments. For purposes of brevity, description of like elements and/or processes employed in other embodiments is omitted.

In some examples, one or more embodiments of method 600 can be implemented by identifying component 122, deploying component 124, merging component 126, and other components that can be used to implement aspects of method 600, in accordance with one or more embodiments. It is appreciated that the operating procedures of method 600 are example operating procedures, and that there can be embodiments that implement more or fewer operating procedures than are depicted, or that implement the depicted operating procedures in a different order than as depicted.

At 602 of method 600, identifying component 122 can, in one or more embodiments, identify a cluster for a change in storage capacity, the cluster having been deployed using a set of node devices that support the cluster. At 604 of method 600, deploying component 124 can, in one or more embodiments based on a capacity specification, deploy a virtual machine on a node device that is not part of the set of node devices. At 606 of method 600, merging component 126 can, in one or more embodiments based on a capacity specification, merge the node device into the set of node devices, resulting in a merged set of node devices to support the cluster and achieve the change in storage capacity.

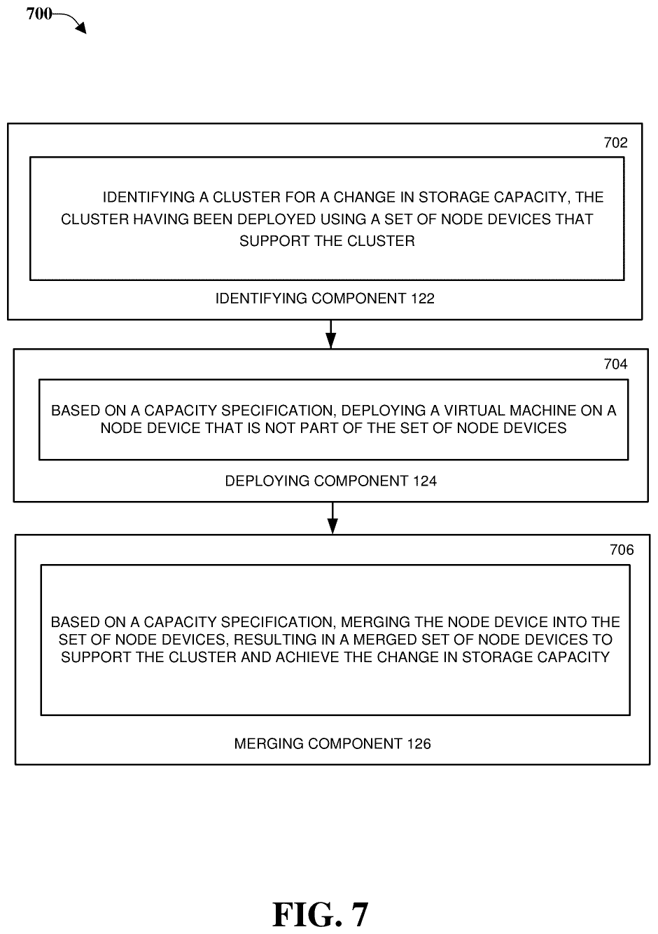

FIG. 7 depicts an example system 700 that can facilitate increasing storage capacity of a storage cluster, in accordance with one or more embodiments. For purposes of brevity, description of like elements and/or processes employed in other embodiments is omitted. Example system 700 can include identifying component 122, deploying component 124, merging component 126, and other components that can be used to implement aspects of system 800, as described herein, in accordance with one or more embodiments.

At 702 of FIG. 7, identifying component 122 can identify a cluster for a change in storage capacity, the cluster having been deployed using a set of node devices that support the cluster. At 704 of FIG. 7, deploying component 124 can, based on a capacity specification, deploy a virtual machine on a node device that is not part of the set of node devices. At 706 of FIG. 7, merging component 126 can, based on the scaling specification based on a capacity specification, merge the node device into the set of node devices, resulting in a merged set of node devices to support the cluster and achieve the change in storage capacity.

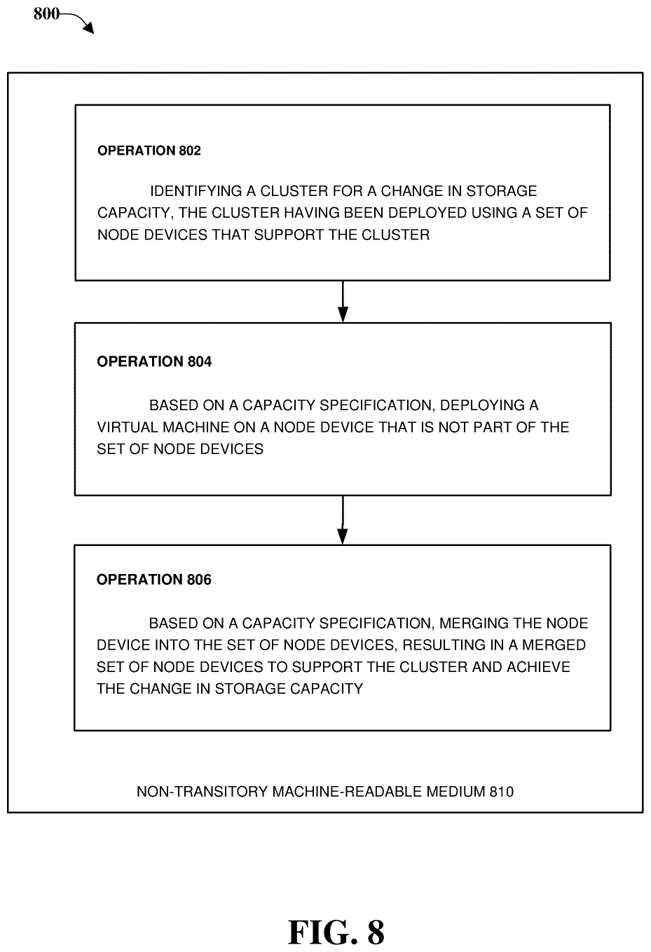

FIG. 8 depicts an example 800 non-transitory machine-readable medium 810 that can include executable instructions that, when executed by a processor of a system, can facilitate increasing storage capacity of a storage cluster, in accordance with one or more embodiments. For purposes of brevity, description of like elements and/or processes employed in other embodiments is omitted.

Operation 802 of FIG. 8 can facilitate generation of identifying component 122 which, in one or more embodiments, can identify a cluster for a change in storage capacity, the cluster having been deployed using a set of node devices that support the cluster. Operation 804 of FIG. 8 can facilitate generation of deploying component 124, which, in one or more embodiments, can, in accordance with one or more embodiments based on a capacity specification, deploy a virtual machine on a node device that is not part of the set of node devices. Operation 806 of FIG. 8 can facilitate generation of merging component 126 which, in one or more embodiments can based on a capacity specification, merge the node device into the set of node devices, resulting in a merged set of node devices to support the cluster and achieve the change in storage capacity.

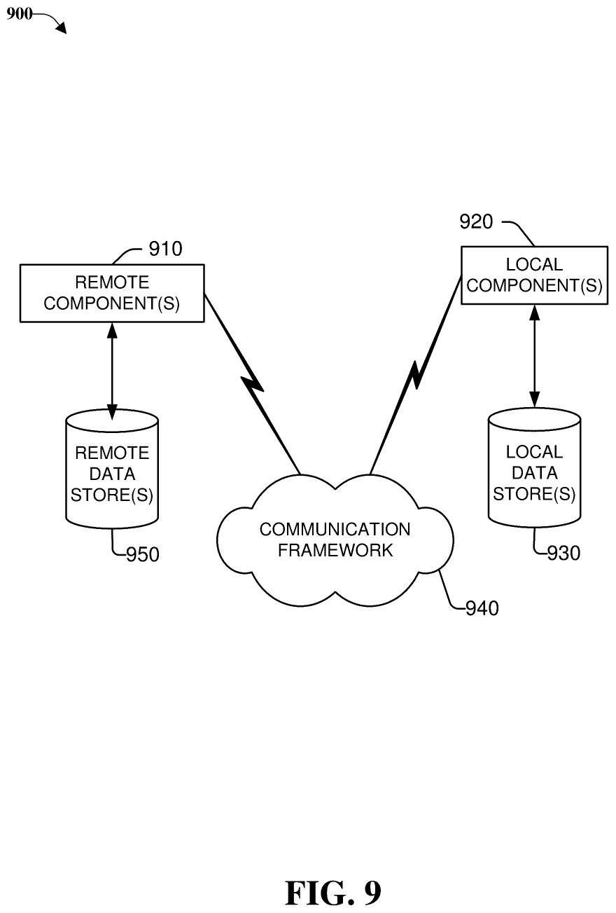

FIG. 9 is a schematic block diagram of a system 900 with which the disclosed subject matter can interact, in accordance with one or more embodiments. The system 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, radio access network devices, gateway devices, femtocell devices, servers, etc.

The system 900 also comprises one or more local component(s) 920. The local component(s) 920 can be hardware and/or software (e.g., threads, processes, computing devices).

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

In the subject specification, terms such as “store.” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 920, non-volatile memory 922, disk storage 924, and memory storage, e.g., local data store(s) 930 and remote data store(s) 950, for which further description is set forth below.

For instance, non-volatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random-access memory, synchronous dynamic random-access memory, double data rate synchronous dynamic random-access memory, enhanced synchronous dynamic random-access memory, SynchLink dynamic random-access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

Referring now to FIG. 10, in order to provide additional context for various embodiments described herein, FIG. 10 and the following discussion are intended to provide a brief, general description of a suitable computing environment 1000 in which the various embodiments described herein can be implemented.

While the embodiments have been described above in the general context of computer-executable instructions that can run on one or more computers, those skilled in the art will recognize that the embodiments can be also implemented in combination with other program modules and/or as a combination of hardware and software. For purposes of brevity. description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and non-volatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per sc.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multiprocessor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide non-volatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are examples and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. As mentioned above, it will be appreciated that the memory components, or computer-readable storage media, described herein can be either volatile memory or non-volatile storage, or can include both volatile and non-volatile storage. By way of illustration, and not limitation, non-volatile storage can include ROM, programmable ROM (PROM), EPROM, EEPROM, or flash memory. Volatile memory can include RAM, which acts as external cache memory. By way of illustration and not limitation, RAM can be available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

Additionally, the terms “core-network,” “core,” “core carrier network,” “carrier-side,” or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method, comprising:
identifying, by a system comprising a processor, a cluster for a change in storage capacity, the cluster having been deployed using a set of node devices that support the cluster; and
based on a capacity specification,
deploying, by the system, a virtual machine on a node device that is not part of the set of node devices, and
merging, by the system, the node device into the set of node devices, resulting in a merged set of node devices to support the cluster and achieve the change in storage capacity.

2. The method of claim 1, wherein deploying the virtual machine comprises:
based on the set of node devices and the cluster, generating metadata associated with the virtual machine; and
creating the virtual machine comprising storing the metadata with the virtual machine to be accessible via the virtual machine.

3. The method of claim 2, wherein the metadata comprises a serial number generated for the virtual machine prior to deploying the virtual machine.

4. The method of claim 1, wherein the set of node devices comprises a range of network addresses to facilitate support of the cluster, and wherein the method further comprises:
based on the capacity specification, expanding, by the system, the range of network addresses to accommodate merging the node device into the set of node devices.

5. The method of claim 1, wherein the node device comprises a first node device, and wherein the method further comprises:
based on the capacity specification, deploying, by the system, a second node device different from the first node device, wherein merging the first node device into the set of node devices comprises asynchronously merging the first node device and the second node device into the set of node devices to support the cluster and achieve the change in storage capacity.

6. The method of claim 1, further comprising: validating, by the system, the deploying of the node device, and the change in storage capacity of the cluster as a result of merging the node device.

7. The method of claim 1, further comprising, before deploying the virtual machine on the node device, determining, by the system, that merging the node device into the set of node devices is not going to result in a limit on number of node devices, which are allowed to be included in the set of node devices, being exceeded.

8. The method of claim 1, further comprising, before deploying the virtual machine on the node device, determining, by the system, that the set of node devices are functioning in accordance with a node specification.

9. The method of claim 1, wherein deploying the virtual machine on the node device comprises creating a virtual network interface card to support the virtual machine.

10. The method of claim 1, wherein identifying the cluster for the change in storage capacity comprises:
based on a capacity condition, monitoring the storage capacity of the cluster; and
based on the monitoring and the capacity condition, generating the capacity specification.

11. Storage equipment, comprising:
a processor; and
a memory that stores executable instructions that, when executed by the processor, facilitate performance of operations, comprising:
receiving a capacity specification that specifies storage resources to be allocated to support a virtual machine, wherein allocation of the storage resources results in allocated storage resources that support the virtual machine,
based on the capacity specification, configuring the virtual machine with a configuration for merging of the storage equipment into a group of storage equipment supporting a storage cluster,
validating the allocated storage resources and the configuration, and
based on the validating, merging the storage equipment into the group of storage equipment supporting the storage cluster.

12. The storage equipment of claim 11, wherein receiving the capacity specification comprises receiving the capacity specification based on a determination that the storage cluster requested additional storage capacity beyond a current storage capacity of the storage cluster.

13. The storage equipment of claim 11, wherein the capacity specification was generated to achieve a specified change in a storage capacity of the storage cluster.

14. The storage equipment of claim 11, wherein merging the storage equipment into the group of storage equipment supporting the storage cluster comprises integrating the virtual machine to support the storage cluster by performing a function of the storage cluster.

15. A non-transitory machine-readable medium, comprising executable instructions that, when executed by a processor of capacity scaling equipment, facilitate performance of operations, comprising:
based on a request for a change in storage capacity of a cluster deployed using node devices supporting the cluster, obtaining a capacity specification; and
based on the capacity specification, deploying a virtual machine on a node device, and merging the node device into the node devices supporting the cluster.

16. The non-transitory machine-readable medium of claim 15, wherein deploying the virtual machine comprises:
based on the node devices and the cluster, generating metadata associated with the virtual machine; and
creating the virtual machine to comprise the metadata.

17. The non-transitory machine-readable medium of claim 15, wherein the node devices comprise a range of network addresses to facilitate the supporting of the cluster, and wherein the operations further comprise:
based on the capacity specification, expanding the range of network addresses to accommodate merging the node device into the node devices supporting the cluster.

18. The non-transitory machine-readable medium of claim 15, wherein the operations further comprise, validating:
deployment of the node device, and
a storage capacity of the node device.

19. The non-transitory machine-readable medium of claim 15, wherein the operations further comprise, before deploying the virtual machine on the node device, determining that merging the node device into the node devices will not exceed a maximum number of node devices in the node devices.

20. The non-transitory machine-readable medium of claim 15, wherein the operations further comprise, before deploying the virtual machine on the node device, determining that the node devices are functioning consistent with at least one specification of a node specification.
